(19) United States
(12) Patent Application Publication
(10) Pub. No.: US 2015/0123843 A1
(43) Pub. Date: May 7, 2015

(54) RECEIVER DUAL-REFLECTOR ANTENNA SYSTEM FOR INTERFERENCE SUPPRESSION ONBOARD SATELLITE

(71) Applicant: LOCKHEED MARTIN CORPORATION, Bethesda, MD (US)

(72) Inventors: Erik LIER, Newtown, PA (US); Moh'd A. Hasan, Yardley, PA (US); Anthony Wykeham Jacomb-Hood, Yardley, PA (US); Matthew George Bray, Yardley, PA (US); Russell T. Baker, Langhorne, PA (US)

(73) Assignee: LOCKHEED MARTIN CORPORATION, Bethesda, MD (US)

(21) Appl. No.: 14/073,759

(22) Filed: Nov. 6, 2013

(51) Int. Cl. G01S 19/21

(52) U.S. Cl. CPC G01S 19/21
USPC 342/352

(57) ABSTRACT

A system for interference suppression onboard a satellite may include an antenna that is configured to receive uplink signals from a ground-coverage area and to generate a first signal. A spot-beam antenna may be configured to receive interference signals and to generate a second signal. A processor may be configured to receive the first signal from the antenna and the second signal from the spot-beam antenna and to perform a cross-correlation to generate a composite signal that includes a null at an interference frequency. The antenna may be a shaped reflector antenna and the spot-beam antenna may be a parabolic reflector antenna.

### STATEMENT REGARDING FEDERALLY SPONSORED RESEARCH OR DEVELOPMENT

Not applicable.

### FIELD OF THE INVENTION

The present invention generally relates to satellite communications, and more particularly to receiver dual-reflector antenna system for interference suppression onboard satellite.

### BACKGROUND

Jamming of uplink satellite antennas has become an increasing threat for disrupting satellite communication services worldwide. A jammer (e.g., a ground jammer) may use various terminals to transmit high power signals at a single frequency towards the satellite to disrupt a particular communication channel or service. Satellite communication service providers are looking for ways to counter this threat, for example, by adding anti-jamming antennas to the payload. Such systems are often expensive, have limited effectiveness, and can disrupt the satellite communication service significantly during a jamming experience.

Existing anti-jamming payloads have added antenna elements distributed around the main antenna to create nulls towards the interferer. Reflector antennas with an active feed array or a direct radiating array can also be used to provide low sidelobe or a null in the direction of the interferer. The main disadvantage of the existing solutions is the cost associated with implementing these solutions. Moreover, in these solutions, the degradation of the antenna gain-to-noise-temperature (G/T) may occur over the full frequency band of the beam rather than being limited to jammer bandwidth, as is desirable.

### SUMMARY

In some aspects, a system for interference suppression onboard a satellite is described. The system may include an antenna that is configured to receive uplink signals from a ground-coverage area and to generate a first signal. A spot-beam antenna may be configured to receive interference signals and to generate a second signal. A processor may be configured to receive the first signal from the antenna and the second signal from the spot-beam antenna and to generate a composite signal with the interference signals suppressed. The antenna may be a shaped reflector antenna and the spot-beam antenna may be a parabolic reflector antenna.

In other aspects, a method for interference suppression onboard a satellite includes receiving uplink signals from a ground-coverage area and generating a first signal. Interference signals may be received and a second signal may be generated based on the interference data. The first signal and the second signal are received and a composite signal with interference signals suppressed is generated by performing a weighted sum.

In yet other aspects, a satellite system may include one or more shaped beam antennas, one or more spot-beam antennas, a payload, and a processor. The one or more spot-beam antennas can be mechanically steerable. The payload may be configured to couple the one or more shaped beam antennas and the one or more spot-beam antennas to the processor and to facilitate coupling first and second signals generated, respectively, by the one or more shaped beam antennas and the one or more spot-beam antennas to the processor, The processor may be configured to perform a weighted sum and to generate composite signals with interference signals suppressed.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific aspects of the disclosure, wherein:

FIG. 1 illustrates a conceptual diagram of an example satellite configuration for interference suppression and corresponding example coverage map and beam profiles, according to certain aspects.

FIGS. 2A-2B are diagrams illustrating examples of a system for interference suppression onboard a satellite and a downlink transmitter, according to certain aspects.

FIG. 3 is a diagram illustrating an example of a cross-correlator system onboard a satellite, according to certain aspects.

FIGS. 4A-4B are diagrams illustrating examples of shaped beam patterns with 3-dB beam-width nulls, according to certain aspects.

FIG. 5 is a flow diagram illustrating an example method for interference suppression onboard a satellite, according to certain aspects.

### DETAILED DESCRIPTION

The present disclosure is directed, in part, to methods and configuration for interference suppression onboard a satellite. The subject technology is generally directed to interference suppression, in particular, through creating a spatial null in a composite signal that is transmitted (e.g., to the ground) to counter an interference source (e.g., a jammer, such as a ground jammer). The disclosed solution is advantageous over the existing solutions in many ways, for example, it can provide the jammer position and can be implemented (e.g., with commercial-off-the-shelf (COTS) components) at significantly lower cost. Moreover, the degradation of the antenna gain-to-noise-temperature (G/T), in the subject technology, is limited to a jammer bandwidth and an area of a spot beam of the system. In some aspects, jammer suppression can be achieved using an auxiliary spot-beam antenna and a digital processor. The digital processing may form a composite signal with 35-40 dB jammer suppression. The composite signal may be formed in a manner that only suppresses signals coming from locations on the ground that are spatially close to the jammer and that are close in frequency to the jammer.

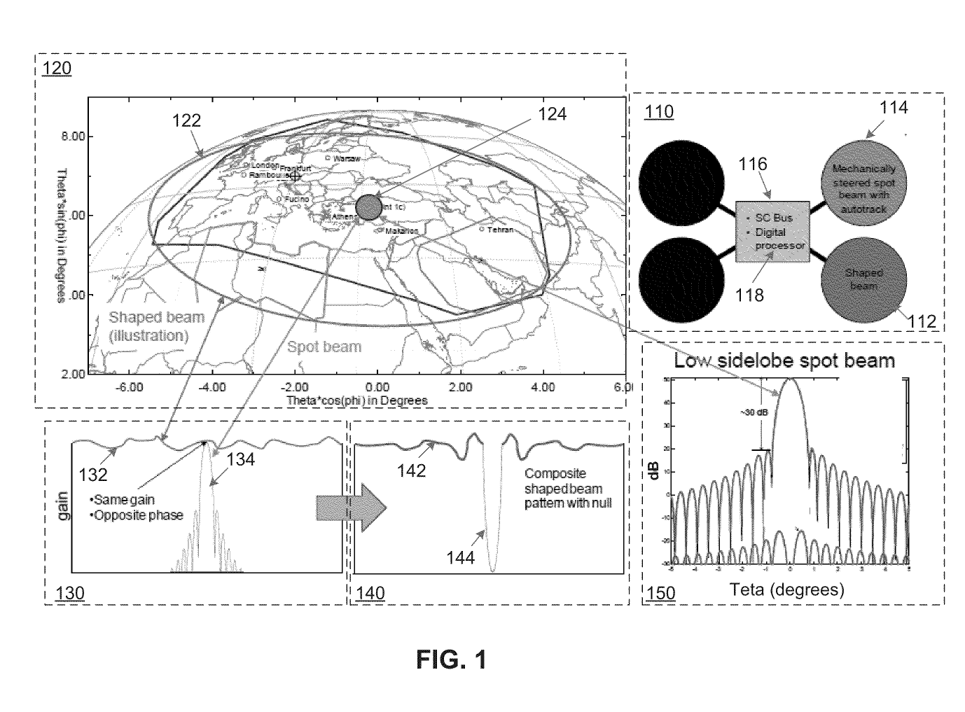

FIG. 1 illustrates a conceptual diagram of an example satellite configuration 110 for interference suppression and corresponding example coverage map 120 and beam profiles 130, 140 and 150, according to certain aspects of the subject technology. The satellite configuration 110 may include one or more antennas 112 (e.g., reflector antennas), one or more spot-beam reflector antennas 114, and a satellite communication bus 116 that provide an infrastructure for holding the reflector antennas 112 and the spot-beam antennas 114 (e.g., spot-beam reflector antennas) and coupling them to a processor (e.g., a digital processor) 118. Examples of a reflector antenna 112 may include a shaped reflector antenna that is configured to produce a shaped beam. The shaped beam may have a pattern 122, as shown in the coverage map 120, and may cover a desired region on the ground. Examples of a spot-beam reflector antenna 114 may include a parabolic reflector antenna that is configured to produce a spot-beam 124, as shown in the coverage map 120.

The spot beam reflector antenna 114 may be mechanically steerable and can be controlled by an auto-tack subsystem. The auto-tack subsystem may point the spot beam in the direction of an interference source (e.g., ground jammer) based on information received from a ground station. In one or more aspects, the processor 118 may provide the digital amplitude of the second signal to an auto-track subsystem. The auto-track subsystem may use the digital amplitude of the second signal to direct the spot-beam of the spot-beam reflector antenna 114 in the direction of the ground jammer. The spot-beam reflector antenna 114 may be configured to scan over a plausible region including the interference source (e.g., the ground jammer). The information regarding the plausible region and interference frequency data may be received from a ground station.

The satellite bus 116 may host a payload to facilitate coupling a first signal corresponding to an antenna pattern 132 and a second signal corresponding to an antenna pattern 134 (shown in the profile 130) generated, respectively, by the reflector antennas 112 and the spot-beam reflector antennas 114 based on the received uplink signals and the interference signals, to the processor 118. The processor 118 may perform cross-correlation to generate a composite signal corresponding to a composite shaped-beam pattern 142 with a null 144, shown in the profile 140. The null 144 is created at an interference frequency (e.g., a jammer frequency or frequency band). The processor 118 may perform the cross-correlation by comparing the first and the second signals, finding a relative amplitude and phase of the first and the second signals, and combining the first and the second signals with same amplitudes and a 180 degree relative phase at the interference frequency to create the composite signal with interference signals suppressed. An enlarged version of the antenna pattern 134 is shown in the profile 150, which depicts a main lobe peaking approximately 30 dB above the side lobes. The width of the null 144 may depend on a distance (e.g., approximately 3 meter) between the reflector antenna 112 and the spot-beam reflector antenna 114. A narrower null 144 in the composite antenna pattern 142 may be achieved by increasing the distance between the reflector antenna 112 and the spot-beam reflector antenna 114.

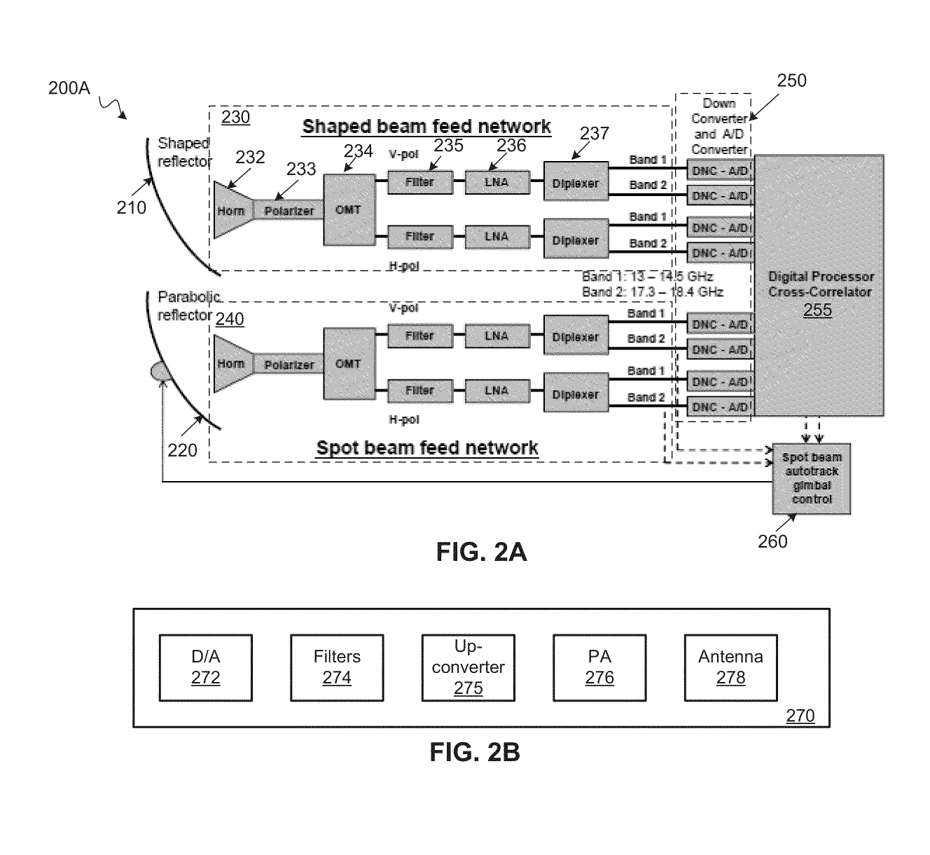

FIGS. 2A-2B are diagrams illustrating examples of a system 200A for interference suppression onboard a satellite (e.g., 110 of FIG. 1) and a downlink transmit subsystem 270, according to certain aspects of the subject technology. The system 200A includes a reflector antenna (e.g., a shaped reflector antenna, hereinafter “shaped antenna”) 210, a spot-beam reflector antenna (e.g., parabolic reflector antenna, hereinafter “parabolic antenna”) 220, a shaped beam feed network 230, a spot-beam feed network 240, a processor (e.g. a digital processor or cross-correlator) 255, down-converter (DNC) and analog-to-digital (A/D) convertor modules 250, and an auto-track subsystem (e.g., a spot beam auto-track gimbal control) 260. The shaped beam feed network 230 may include a feed (e.g., horn) 232, a polarizer 233, an ortho-mode transducer (OMT) 234, and vertical polarization (V-pol) and horizontal polarization (H-pol) receive chains each including a number of known blocks such as a filter 235, a low-noise amplifier 236, and a diplexer 237.

The polarizer 233 converts the circularly polarized signal received from the feed 232 to V-pol and H-pol beams, each of which can be processed in the separate V-pol and H-pol receive chains to generate a number of (e.g., two) radio-frequency (RE) signals at corresponding number of (e.g., two) frequency bands (e.g., channels). The spot-beam feed network 240 is similar to the shaped beam feed network 230. In some aspects, the two frequency bands may include a first band at 13-14.5 GHz and a second band at 17.3-18.4 GHz. The RF signal of each band can be down-converted and converted to a digital signal (e.g., a digital form of the first signal or the second signal) via the DNC-A/D modules 250. The digital processor 255 may process the digital signals of various V-pol and H-pol bands of the shaped beam feed network 230 and the spot-beam feed network 240 to produce digital signals corresponding to the composite signals (e.g., 142 of FIG. 1) including nulls (e.g., 144 of FIG. 1) at the frequency of an interference source (e.g., a ground jammer), as discussed in more detail below. The auto-track subsystem 260 may use the signals from one or more channels or from the processor 255 to point the spot beam of the parabolic antenna 220 in the direction of the jammer.

The digital signals produced by the digital processor 255 may be processed by a downlink transmit subsystem 270 to frequency translate the composite signal and transmit the composite signal to the ground. The downlink transmit subsystem 270 may include a number of known blocks such a digital-to-analog (D/A) convertor 272, one or more filters 274 (e.g., pass-band filters), one or more up-convertor modules 275, one or more power amplifiers (PAs) 276, and one or more antennas 278.

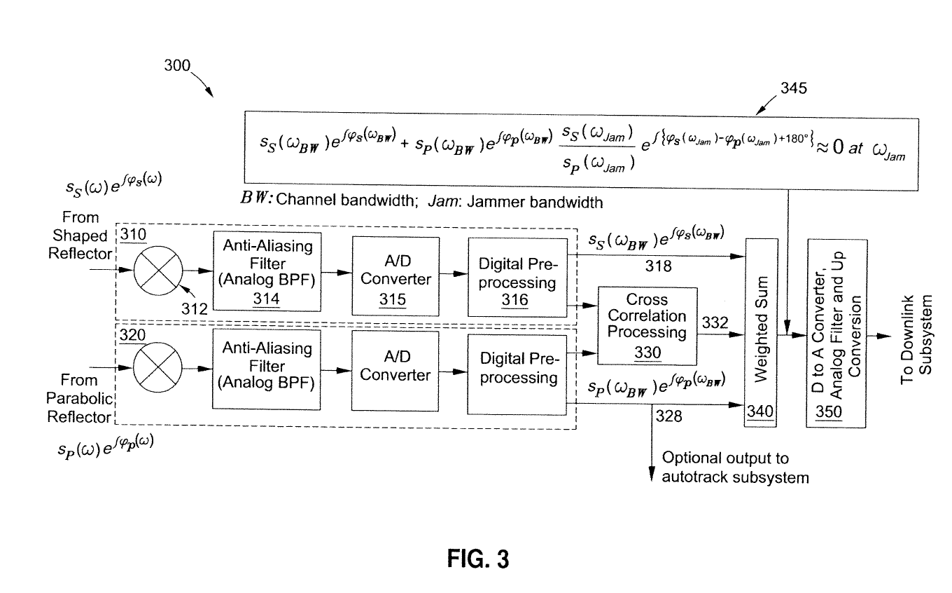

FIG. 3 is a diagram illustrating an example of a cross-correlator system 300 onboard a satellite, according to certain aspects of the subject technology. The cross-correlator system 300 may represent and perform the functionalities of the DNC-A/D modules 250 and the processor 255 of FIG. 2A. For simplicity, the cross-correlator system 300 is shown for a single channel of the system 200A of FIG. 2A, which can include multiple channels. The cross-correlator system 300 includes a shaped-beam preprocessing chain 310, a spot-beam preprocessing chain 320, a cross-correlation processing module 330, a weighted sum module 340, and a D/A convertor 350. The shaped-beam preprocessing chain 310 and the spot-beam preprocessing chain 320 receive their respective inputs from the shaped-beam feed network 230 and the spot-beam feed network 240 of FIG. 2A and include similar modules.

The shaped-beam preprocessing chain 310 (or the spot-beam preprocessing chain 320) includes known modules such as a down-converter 312, an anti-aliasing filter 314, an A/D converter 315, and a digital pre-processing module 316. Examples of the anti-aliasing filter 314 may include an analog band-pass filter (BPF) that can prepare the analog down-converted signal (e.g., an intermediate-frequency (IF) signal) for A/D conversion. The digital pre-processing module 316 may provide additional processing of the digital signal by further down-converting the digital signal (e.g., the IF signal) to baseband, digital filtering of the received signals, and down-sampling (e.g., decimation). In some aspects, digital filtering may be used to separate the received signal into two parts: a first sub-band that contains interference, and a second sub-band that does not contain interference. If the received signal is separated in this manner, the cross-correlation may only be performed on the sub-band that contains interference. In this case, the weighted sum module not only combines the filtered signals from the two antennas to suppress the interference present in these signals, it can also combine this composite sub-band with suppressed interference with the sub-band which did not contain interference. This approach protects signals coming from a ground station close to the interferer but using a signal at a different frequency than the interferer from being suppressed.

The respective output signals 318 and 328 of the digital pre-processing modules 316 of the shaped-beam preprocessing chain 310 and the spot-beam preprocessing chain 320 are fed to the cross-correlation processing module 330 and the weighted sum module 340. The cross-correlation processing module 330 may find an amplitude ratio and a phase ratio of the signals 318 and 328 and may provide the ratios to the weighted sum module 340. The weighted sum module 340 may combine the received signals with appropriate weights to generate a digital composite signal 342, the mathematical form of which is shown in text box 345. The digital composite signal 342 is converted, by the D/A convertor 350, to an analog composite signal 352 that is ready to be delivered to the downlink subsystem for transmission to the ground. The signal 328 may be optionally provided to the auto-track subsystem 260 of FIG. 2A.

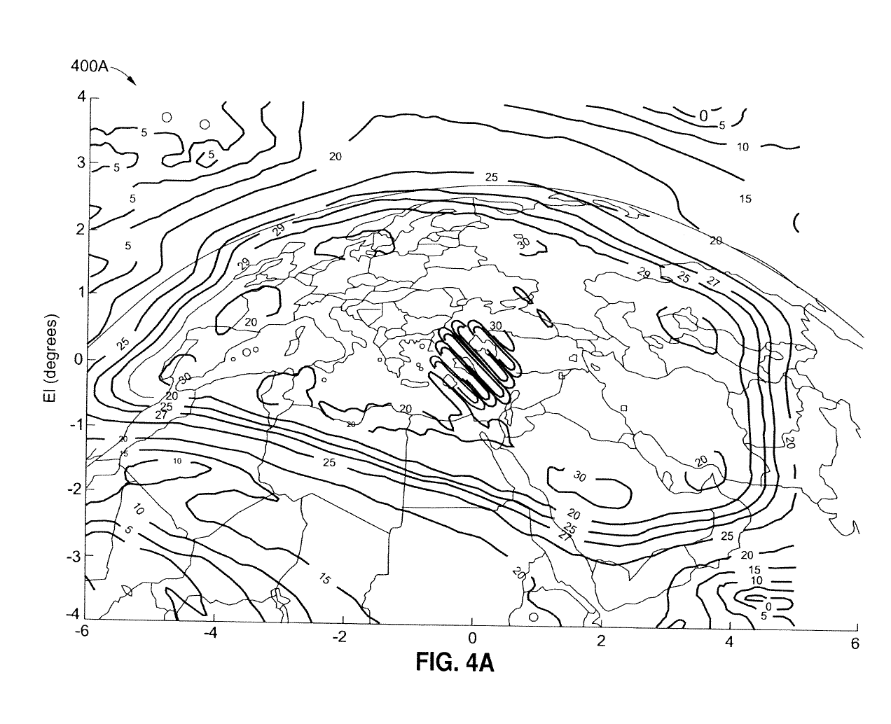

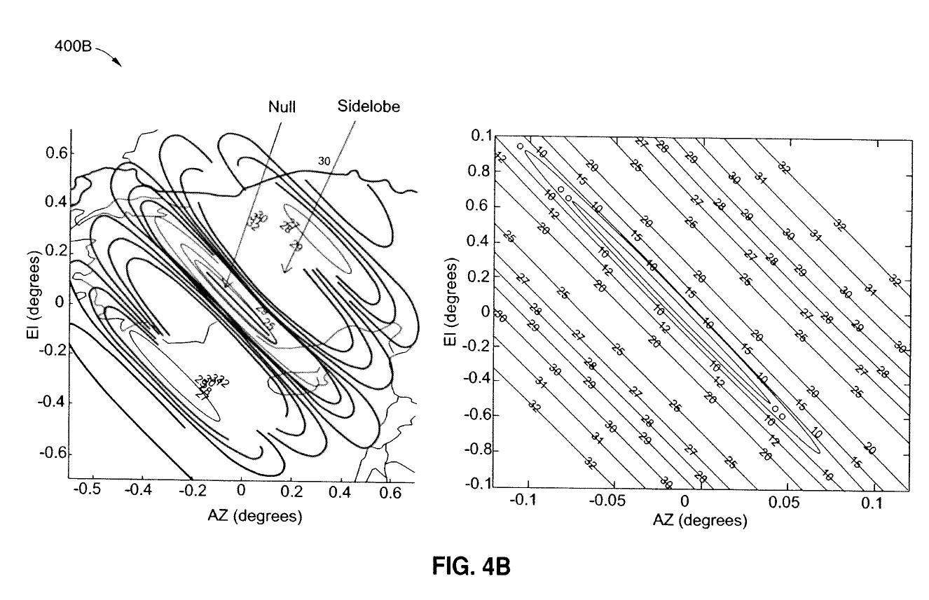

FIGS. 4A-4B are diagrams illustrating examples of composite shaped beam patterns formed by the digital processor, according to certain aspects of the subject technology. In the example beam coverage diagram 400A, the vertical and horizontal axes are, respectively, the elevation (EL) angle and the azimuthal (AZ) angle in degrees. The spot beam is seen in the middle of the shaped-beam coverage diagram 400A and, with more zoom in, is shown in diagrams 400B of FIG. 4B. The diagrams 400B show the 3-dB beam-width nulls with side-lobes. The spatial null may be created only at the frequency of the jammer signal but signals at a different frequency are not impacted. The null is localized to the spot-beam footprint only, and areas outside the spot beam at any channel are not affected by the anti-jam process.

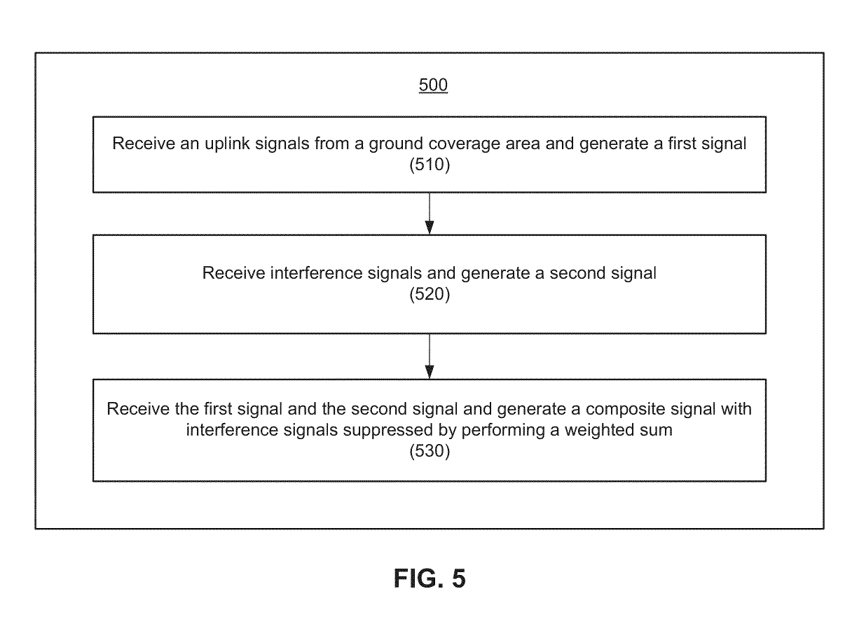

FIG. 5 is a flow diagram illustrating an example method 500 for interference suppression onboard a satellite (e.g., 110 of FIG. 1), according to certain aspects of the subject technology. The steps of the method 500 do not need to be performed in the order shown and one or more steps may be omitted. At operation block 510, uplink signals may be received (e.g., by 112 of FIG. 1 or 210 of FIG, 2A) from a ground-coverage area and a first signal (e.g., corresponding to 132 of FIG. 1) may be generated based on the uplink signals. Interference signals may be received (e.g., by 114 of FIG. 1 or 220 of FIG. 2A) and a second signal (e.g., corresponding to 134 of FIG. 1) may be generated based on the interference signals (operation block 520). At operation block 530, the first signal and the second signal may be received and the first signal and the second signal may be used to generate a composite signal (e.g., corresponding to 142 of FIG. 1) with interference signals suppressed by performing a weighted sum (e.g., by 340 of FIG. 3).

In some aspects, the subject technology is related to interference suppression, and in particular to methods and configurations for interference (e.g., jammer) suppression onboard satellite. In some aspects, jammer suppression can be achieved using an auxiliary spot-beam antenna and a digital processor. The digital processing may enable 35-40 dB jammer suppression. The null may be created only at the frequency of the jammer signal and VSATs spatially close to the jammer but at a different frequency are not impacted. The null is localized to the spot-beam footprint only, and areas outside the spot beam at any channel are not affected by the anti-jam process. The disclosed solution may be less expensive than existing approaches. The complexity and cost of the digital processor may depend on the band-width and the number of simultaneous jammers. In some aspects, the subject technology may be used in various markets, including for example and without limitation, advanced networks, data transmission and communications, and radar and active phased array markets.

The description of the subject technology is provided to enable any person skilled in the art to practice the various aspects described herein. While the subject technology has been particularly described with reference to the various figures and aspects, it should be understood that these are for illustration purposes only and should not be taken as limiting the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various aspects described throughout this disclosure that are known or later come to be known to those of ordinary skill in the art are expressly incorporated herein by reference and intended to be encompassed by the subject technology. Moreover, nothing disclosed herein is intended to be dedicated to le public regardless of whether such disclosure is explicitly recited in the above description.

Although the invention has been described with reference to the disclosed aspects, One having ordinary skill in the art will readily appreciate that these aspects are only illustrative of the invention. It should be understood that various modifications can be made without departing from the spirit of the invention. The particular aspects disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative aspects disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and operations. All numbers and ranges disclosed above can vary by some amount. Whenever a numerical range with a lower limit and an upper limit is disclosed, any number and any subrange falling within the broader range are specifically disclosed. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted.

What is claimed is:

1. A system for interference suppression onboard a satellite, the system comprising:
an antenna configured to receive uplink signals from a ground-coverage area and to generate a first signal;
a spot-beam antenna configured to receive interference signals and to generate a second signal; and
a processor configured to receive the first signal from the antenna and the second signal from the spot-beam antenna and to generate a composite signal with the interference signals suppressed.

2. The system of claim 1, wherein the processor is configured to filter the first signal from the antenna and the second signal from the spot-beam antenna prior to generating the composite signal with the interference signals suppressed only at selected frequencies, and wherein the processor comprises a digital cross-correlator and summer, and wherein the digital cross-correlator is configured to perform the cross-correlation by comparing the first and the second signals, finding a relative amplitude and phase of the first and the second signals, and wherein the summer is configured to combine the first and the second signals with same amplitudes and a 180 degree relative phase at the interference frequency to create the composite signal with the interference signals suppressed.

3. The system of claim 1, wherein the antenna comprises a shaped reflector antenna, wherein the shaped reflector is configured to provide a shaped beam.

4. The system of claim 1, wherein the spot-beam antenna comprises a parabolic reflector antenna and is configured to provide a spot beam in a direction of an interference source, and wherein the spot-beam reflector antenna is mechanically steerable.

5. The system of claim 4, further comprising an auto-track subsystem configured to facilitate steering of the spot-beam reflector antenna to point the spot beam of the spot-beam reflector antenna in the direction of le interference source and to provide an estimate of the location of a signal source.

6. The system of claim 1, wherein the cross-correlator is configured to provide a digital amplitude of the second signal to an auto-track subsystem, wherein the auto-track subsystem is configured to use the digital amplitude of the second signal to direct a spot-beam of the spot-beam antenna in a direction of an interference source, wherein the interference source comprises a ground jammer, and wherein the system is configured to provide a location of the interference source.

7. The system of claim 1, wherein the spot-beam antenna is configured to scan over a plausible region including an interference source, wherein the system receives information regarding the plausible region and interference frequency data from a ground station.

8. The system of claim 1, further comprising a digital-to-analog converter (DAC) configured to convert the composite signal to an analog signal, and a downlink subsystem configured to transmit down the composite signal toward the ground jammer.

9. The system of claim 1, wherein a composite pattern of antenna and the spot-beam antenna includes a null, and wherein the null is localized to a spot-beam foot-print of the spot-beam antenna, and wherein a narrower null in the composite pattern is achievable by increasing a distance between the antenna and the spot-beam antenna.

10. A method for interference suppression onboard a satellite, the method comprising:
receiving uplink signals from a ground-coverage area and generating a first signal based on the uplink signals;
receiving interference signals and generating a second signal based on the interference signals; and
receiving the first signal and the second signal and generating a composite signal with the interference signals suppressed by performing a weighted sum.

11. The method of claim 10, wherein performing the weighted sum comprises determining weighing factors based on cross-correlation, and further comprising performing cross-correlation using a digital cross-correlator, and wherein performing the cross-correlation comprises comparing the first and the second signals, finding a relative amplitude and phase of the first and the second signals.

12. The method of claim 10, wherein receiving the uplink signals from the ground-coverage area comprises using a shaped reflector antenna, wherein the shaped reflector is configurable to provide a shaped beam.

13. The method of claim 10, wherein receiving interference signals comprises using a spot-beam reflector antenna that comprises a parabolic reflector antenna and is configurable to provide a spot beam in a direction of an interference source, and the method further comprises mechanically steering the spot-beam reflector antenna.

14. The method of claim 13, further comprising facilitating, by using an auto-track subsystem, steering of the spot-beam reflector antenna to point the spot beam of the spot-beam reflector antenna in the direction of the interference source.

15. The method of claim 10, further comprising providing a digital amplitude of the second signal to an auto-track subsystem, configuring the auto-track subsystem to use the digital amplitude of the second signal to direct a spot-beam of the spot-beam antenna in a direction of an interference source, and reporting an estimate of a location of the interference source.

16. The method of claim 10, further comprising receiving information regarding a plausible region and interference frequency data from a ground station, and scanning over the plausible region including an interference source, and wherein scanning over the plausible region includes using an auto-track subsystem.

17. The method of claim 16, further comprising converting the composite signal to an analog signal, and a transmitting down the composite signal.

18. The system of claim 10, wherein a composite pattern of the antenna and the spot-beam antenna includes a null, and wherein the null is localized to a spot-beam foot-print of the spot-beam antenna, and achieving a narrower null in the composite signal by increasing a distance between the antenna and the spot-beam antenna.

19. A satellite system, comprising:
one or more shaped beam antennas;
one or more spot-beam antennas that are mechanically steerable;
a processor configured to perform cross-correlation; and
a payload configured to couple the one or more shaped beam antennas, the one or more spot-beam antennas, and the processor and to facilitate coupling first and second signals generated, respectively, by the one or more shaped beam antennas and the one or more spot-beam antennas to the processor,
wherein the processor is configured to perform a weighted sum to generate composite signals with interference signals suppressed.

20. The satellite system of claim 19, wherein:
the processor comprises a digital cross-correlator and a summer, wherein the digital cross-correlator is configured to perform the cross-correlation by comparing the first and the second signals, finding a relative amplitude and phase of the first and the second signals, and wherein the summer is configured to combine the first and the second signals with same amplitudes and 180 degree relative phases at the interference frequencies to create the composite signal with the interference signals suppressed, and wherein the satellite system further comprises an auto-track subsystem configured to facilitate steering of the one or more spot-beam antennas to point the spot beams of the one or more spot-beam antennas in one or more directions of one or more interference sources and to provide an estimate of the location of one or more signal sources.
